(19) United States
(12) Patent Application Publication
(10) Pub. No.: US 2007/0148556 A1
(43) Pub. Date: Jun. 28, 2007

(54) Photosensitive composition for volume hologram recording

(76) Inventors: Yoshihito Maeno, Tokyo (JP); Hiroyuki Ohtaki, Tokyo (JP); Toshio Yoshihara, Tokyo (JP); Junichiro Ihara, Okayama (JP); Fumio Matsui, Okayama (JP)

Correspondence Address: LADAS & PARRY LLP, 224 SOUTH MICHIGAN AVENUE, SUITE 1600, CHICAGO, IL, 60604, US

(21) Appl. No.: 10/583,880

(22) PCT Filed: Dec. 21, 2004
(86) PCT No.: PCT/JP04/19122

§ 371 Date: Jan. 3, 2007

(30) Foreign Application Priority Data
Dec. 22, 2003 (JP) 2003-425490

(51) Int. Cl. G03H 1/04

(52) U.S. Cl. 430/1; 430/281.1; 430/280.1; 359/3; 430/2

(57) ABSTRACT

A volume hologram recording material having a composition that is adjusted in accordance with a recording wavelength in a visible region set individually and specifically, and is excellent in sensitivity or hologram recording performance. A photosensitive composition for volume hologram recording having a photopolymerizable compound, a photopolymerization initiator and a sensitizing dye, and a maximum absorption wavelength of the sensitizing dye deviates by 14 nm or more from a predetermined volume hologram recording wavelength set in a visible region and the composition itself has absorption at the volume hologram recording wavelength.

### TECHNICAL FIELD

The present invention relates to a photosensitive composition suitable for recording a volume hologram.

### BACKGROUND ART

A volume hologram is produced in such a manner that objective light and reference light high in coherence and equal in wavelength are interfered to enter a hologram recording portion comprising a volume hologram recording material, and three-dimensional information regarding an object is recorded inside of a recording material layer as an interference fringe. The interference fringe is recorded, for example, as a refractive index modulation corresponding to the brightness and darkness of the interferential light. The volume hologram is widely utilized in the field of, for example, design use, security use, optical element use or the like since the volume hologram can three-dimensionally express a recorded subject, has high diffraction efficiency and wavelength selectivity, and requires advanced manufacturing technique or the like.

As a photosensitive composition for recording the volume hologram, there are materials such as silver salt, dichromated gelatin and the like in old times. These materials are excellent in hologram recording performance, however, these materials are not preferable for mass-production since operation is cumbersome due to wet development, storage stability is inferior or the like.

A dry developing type photopolymer material is simple in method of producing hologram in comparison with wet developing materials, and thus has been developed in recent years. As the dry developing type photopolymer material, OmniDex series manufactured by DuPont is commercially available in mass-production level. The material contains a radical polymerizable monomer, a binder resin, a photoradical polymerization initiator and a sensitizing dye as main components, and can record a volume hologram by utilizing a refractive index difference between the radical polymerizable monomer and the binder resin (for example, Japanese Patent No. 2,664,234).

Also, materials using both radical polymerization and cationic polymerization are reported. For example, Japanese Patent No. 2,873,126 discloses a system using a monomer having a diarylfluorene skeleton as a radical polymerizable monomer having a high refractive index and a cationic polymerizable monomer having smaller refractive index than the radical polymerizable monomer. In the system, a high refractive index component polymerizes by radical polymerization upon interference exposure, and then an image is fixed by cationic polymerization upon fixing exposure.

Also, materials utilizing cationic polymerization are disclosed in, for example, the description of U. S. Pat. No. 5,759,721 or the like. The materials have advantage that there is no oxygen inhibition in a radical polymerization system.

As a light source having high coherence used for the volume hologram recording, a visible laser light is used. In order to improve photosensitivity by the visible laser light, generally, a so-called sensitizing dye which can sensitize with respect to a wavelength of the visible laser light is added to the volume hologram recording material. As the sensitizing dye useful for the volume hologram recording, there are dyes disclosed in, for example, Japanese Patent Application Laid-Open (JP-A) No. Hei. 5-27436, JP-A No. Hei. 6-324615, JP-A No. Hei. 7-281436 or the like. Also, JP-A No. 2000-109509, JP-A No. 2000-109510 or the like discloses a combination of sensitizing dye and photopolymerization initiator.

However, sensitivity upon interference exposure and hologram recording performance are not always exhibited as they are expected, and often can be just known by actually recording a hologram using a visible laser light individually and specifically adopted. Hence, selection of recording material and setting of recording condition take a lot of trouble.

### DISCLOSURE OF THE INVENTION

The present invention has been achieved in light of the above-stated conventional problems. An object of the present invention is to provide a volume hologram recording material wherein a composition is adjusted in accordance with a recording wavelength in a visible region set individually and specifically, and is excellent in sensitivity or hologram recording performance.

In order to achieve the above object, a photosensitive composition for volume hologram recording provided by the present invention is a photosensitive composition for volume hologram recording comprising a photopolymerizable compound as a refractive index modulation component, a photopolymerization initiator and a sensitizing dye which increases sensitivity with respect to a wavelength of a visible region of the photopolymerization initiator, wherein a maximum absorption wavelength of the sensitizing dye deviates by 14 nm or more from a predetermined volume hologram recording wavelength set in a visible region and the composition itself has absorption at the volume hologram recording wavelength.

By adjusting a composition of the photosensitive composition for hologram recording so as to satisfy the above certain relationship with respect to the recording wavelength set individually and specifically upon interference exposure using a recording wavelength in a visible region, sensitizing ability of the sensitizing dye can be fully brought out. Hence, excellent sensitivity or hologram recording performance can be obtained.

The photosensitive composition for volume hologram recording of the present invention may further contain a binder resin and/or a thermosetting compound. By compounding the binder resin to the composition, the photosensitive composition can be more easily utilized as a dry developing type hologram forming material. Also, a hologram recording portion containing a photosensitive composition for volume hologram recording having the thermosetting compound compounded is fixed by a heat treatment after interference exposure, and has a refractive index increased since a cationic polymerizable compound is crosslinked due to a strong acid generated upon interference exposure so as to increase refractive index modulation. Also, effect to increase resistance such as heat resistance, weather resistance or the like and mechanical strength is high since a crosslinked structure is formed.

As the sensitizing dye of the photosensitive composition for volume hologram recording, a cyclopentanone skeleton containing compound represented by the following general formula (1) may be preferably used: 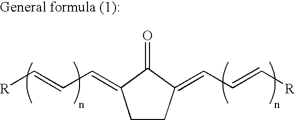
wherein, “R” is a carbon-nitrogen containing substituent represented by “NₓC_{y}” in which x=1 to 4, y=8 to 30; “R” may contain a hydrogen atom and/or a halogen atom; “n” is an integer of 0 to 3.

Furthermore, as the photopolymerization initiator, a compound containing diaryliodonium skeleton represented by the following general formula (2) may be preferably used. 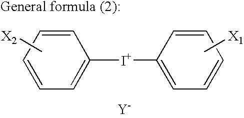
wherein, each of “X₁” and “X₂” is independently an alkyl group having 1 to 20 carbons, halogen or an alkoxyl group having 1 to 20 carbons; “Y” is a monovalent anion.

Furthermore, the photopolymerizable compound may be preferably at least one kind selected from the group consisting of a photoradical polymerizable compound and a photocationic polymerizable compound.

Furthermore, the photosensitive composition for volume hologram recording may further contain a second refractive index modulation component having different refractive index from the photopolymerizable compound. When the photopolymerizable compound as a first refractive index modulation component and the second refractive index modulation component are in combination, a refractive index difference between a strongly exposed portion and a weakly exposed portion can be increased by the volume exclusion effect upon exposure.

In the preferable embodiment of the present invention, a photosensitive composition for volume hologram recording using a sensitizing dye in which the maximum absorption wavelength deviates by 14 nm or more with respect to a predetermined volume hologram recording wavelength set within a region of 514 nm to 560 nm (green region) is provided. The composition has high diffraction efficiency when producing a green hologram.

In a preferable embodiment of the present invention, by using the photosensitive composition for volume hologram recording, a volume hologram having a diffraction efficiency of 80% or more can be obtained.

According to the composition for hologram recording of the present invention and a method of hologram recording using the composition, sensitizing ability of the sensitizing dye can be fully brought out by adjusting a composition of the composition for hologram recording so as to satisfy the above certain relationship with respect to the recording wavelength set individually and specifically upon interference exposure using a recording wavelength in a visible region. Hence, excellent sensitivity or hologram recording performance can be obtained.

According to the present invention, diffraction efficiency or refractive index modulation amount Δn can be enlarged and a visually bright and excellent hologram can be formed. Thus, for example, a volume hologram having diffraction efficiency of 80% or more, preferably 90% or more, can be produced.

### BRIEF DESCRIPTION OF DRAWING

In the accompanying drawing,

FIG. 1 is a graph showing a method of calculating diffraction efficiency.

### BEST MODE FOR CARRYING OUT THE INVENTION

Hereinafter, the present invention will be explained in more detail. In the present description, “(meth)acrylate” represents acrylate and methacrylate, “(meth) acryl” represents acryl and methacryl, and “(meth) acryloyl” represents “acryloyl” and “methacryloyl”.

A photosensitive composition for volume hologram recording provided by the present invention (hereafter it may be referred as “a composition for hologram recording”) has a composition comprising, as essential components, a photopolymerizable compound as a refractive index modulation component, a photopolymerization initiator and a sensitizing dye which increases sensitivity of the photopolymerization initiator with respect to a visible region wavelength, wherein the maximum absorption wavelength of the sensitizing dye deviates by 14 nm or more from a predetermined volume hologram recording wavelength set in a visible region and the composition itself has absorption at the volume hologram recording wavelength.

Even if a recording wavelength of laser light used for the interference exposure is consistent with the maximum absorption wavelength of the sensitizing dye compounded in the composition for hologram recording, sensitizing ability of the sensitizing dye cannot be fully exhibited.

To the contrary, the present invention adjusts a composition of the composition for hologram recording so as to satisfy the above certain relationship with respect to the recording wavelength set individually and specifically upon interference exposure using a recording wavelength in a visible region, hence, sensitizing ability of the sensitizing dye can be fully brought out. Therefore, an excellent sensitivity or hologram recording performance can be obtained.

Therefore, by using a sensitizing dye in which the maximum absorption wavelength deviates by 14 nm or more with respect to a recording wavelength set within a red (630 to 670 nm) region, a composition suitable for producing a red hologram can be obtained. By using a sensitizing dye in which the maximum absorption wavelength deviates by 14 nm or more with respect to a recording wavelength set within a green (514 to 560 nm) region, a composition suitable for producing a green hologram can be obtained. By using a sensitizing dye in which the maximum absorption wavelength deviates by 14 nm or more with respect to a recording wavelength set within a blue (420to488nm) region, a composition suitable for producing a blue hologram can be obtained.

The maximum absorption wavelength of the sensitizing dye shifts according to a solvent to dissolve the sensitizing dye to prepare a measuring sample or other components which coexist in the measuring sample. Hence, in the present invention, the maximum absorption wavelength of the sensitizing dye in the actually prepared composition for hologram recording is measured. If the composition for hologram recording is prepared in the state of a coating liquid using a solvent, the maximum absorption wavelength of the sensitizing dye in the state not containing the solvent by drying the composition for hologram recording is measured.

Also, the absorption wavelength of the composition for hologram recording shifts according to the solvent for dissolving the composition. Hence, the composition for hologram recording is confirmed to have absorption at recording wavelength in the state of not containing the solvent.

The sensitizing dye is selected from the sensitizing dyes which can convert radiation energy of recording light having a wavelength at a visible region into activation energy of the photopolymerization initiator. The above sensitizing dye may not be particularly limited if the maximum absorption wavelength deviates from the recording wavelength adopted individually and specifically by 14 nm or more to the high wavelength side or low wavelength side.

It is, however, necessary that the composition for hologram recording of the present invention has absorption at the recording wavelength when absorption spectrum of the composition itself is measured in the state not containing the solvent. The absorption of the composition at the recording wavelength is a total absorption of the compounded components including the sensitizing dye, the photopolymerization initiator and so on. However, in many cases, contribution of the sensitizing dye is large. Therefore, the sensitizing dye having absorption at the recording wavelength is preferable and it is preferable that the absorption is large.

As the sensitizing dye, there may be, for example, a cyanine dye, a melocyanine dye, a coumarin dye, a ketocoumarin dye, a cyclopentanone dye, a cyclohexanone dye, a thiopyrillium salt dye, a quinoline dye, a styrylquinoline dye, a thioxanthene dye, a xanthene dye, an oxonol dye, a rhodamine dye, a pyrillium salt dye or the like.

As a specific example of the cyanine or melocyanine dye, there may be 3,3′-dicarboxyethyl-2,2′thiocyanine bromide, 1-carboxymethyl-1′-carboxyethyl-2,2′-quinocyanine bromide, 1,3′-diethyl-2,2′-quinothiacyanine iodide, 3-ethyl-5-[(3-ethyl-2(3H)-benzothiazolidene)ethylidene]-2-thioxo-4-oxazolidine or the like.

As a specific example of the coumarin or ketocoumarin dye, there may be3-(2′-benzoimidazole)-7-diethylaminocoumarin, 3,3′-carbonylbis(7-diethylaminocoumarin), 3,3′-carbonylbiscoumarin, 3,3′-carbonylbis(5,7-dimethoxycoumarin), 3,3′-carbonylbis(7-acetoxycoumarin) or the like.

As a specific example of the cyclohexanone dye, there may be 2,6-bis(4-dimethylaminobenzylidene)cyclohexanone, 2,6-bis(4-diethylaminobenzylidene)cyclohexanone, 2,6-bis(4-dimethylaminocinnamilidene)cyclohexanone, 2,6-bis(4-diethylaminocinnamilidene)cyclohexanone, 2,6-bis(4-N-ethyl-N-carbomethoxymethylaminobenzylidene) cyclohexanone and a sodium salt thereof, 2,6-bis(4-N-methyl-N-cyanoethylaminobenzylidene) cyclohexanone, 2,6-bis(4-N-ethyl-N-chloroethylamino cinnamilidene)cyclohexanone or the like.

As a specific example of the cyclopentanone dye, there may be 2,5-bis(4-dimethylaminobenzylidene)cyclopentanone, 2,5-bis(4-diethylaminobenzylidene)cyclopentanone, 2,5-bis(4-dibutylaminobenzylidene)cyclopentanone, 2,5-bis[(2,3,6,7-tetrahydro-1H,5H-benzo[i,j]quinolidine-9-yl)methylene]cyclopentanone, 2,5-bis [2-(1,3,3-trimethyl -1,3-dihydro-2(2H)-indolinylidene)ethylidene]cyclopentanone, 2,5-bis[2-(1-ethyl-2(1H)-naphtho[1,2-d]thiazolinylidene) ethylidene]cyclopentanone, 2,5-bis(4-dimethylamino cinnamilidene)cyclopentanone, 2,5-bis(4-N-ethyl-N-carbomethoxymethylaminobenzylidene)cyclopentanone and a sodium salt thereof, 2,5-bis(4-N-methyl-N-cyanoethylamino benzylidene)cyclopentanone, 2,5-bis(4-N-ethyl-N-chloroethyl aminocinnamilidene)cyclopentanone or the like.

Particularly, as the cyclopentanone dye, a cyclopentanone skeleton containing compound represented by the following general formula (1) is preferable: 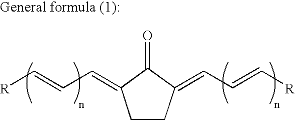
wherein, “R” is a carbon-nitrogen containing substituent represented by “NₓC_{y}” in which x=1 to 4, y=8 to 30; “R” may contain a hydrogen atom and/or a halogen atom; “n” is an integer of 0 to 3.

As a specific example of the compound represented by the general formula (1), there may be 2,5-bis(4-dimethylaminobenzylidene)cyclopentanone, 2,5-bis(4-diethylaminobenzylidene)cyclopentanone, 2,5-bis(4-dibutylaminobenzylidene)cyclopentanone, 2,5-bis[(2,3,6,7-tetrahydro-1H,5H-benzo[i,j]quinolidine-9-yl)methylene]cyclopentanone, 2,5-bis[2-(1,3,3-trimethyl -1,3-dihydro-2(2H)-indolinylidene)ethylidene]cyclopentanone, 2,5-bis[2-(1-ethyl-2(1H)-naphtho[1,2-d]thiazolinylidene) ethylidene]cyclopentanone, 2,5-bis[4-(dimethylamino cinnamilidene)cyclopentanone, 2,5-bis[4-N-ethyl-N-carbo methoxymethylaminobenzylidene) cyclopentanone and a sodium salt thereof, 2,5-bis(4-N-methyl-N-cyanoethylamino benzylidene)cyclopentanone, 2,5-bis(4-N-ethyl-N-chloro ethylaminocinnamilidene)cyclopentanone or the like.

However, suitable sensitizing dyes may not be limited thereto.

In the case of producing a volume hologram for use requiring high transparency such as an optical element or the like, it is preferable to use a sensitizing dye which decomposes or changes structure to become transparent by post-process after hologram recording or post treatment such as heating, ultraviolet irradiation or the like. As the dye which can be transparent in the post-process or the post treatment, there may be the cyanine dye, the melocyanine dye, the coumarin dye, the ketocoumarin dye and the cyclopentanone dye.

Herein, “transparent” means that it is visually transparent in the area out of the hologram recording portion or a transmittance of the visible region (wavelength of 400 to 700 nm) is 60% or more.

As aforementioned, the sensitizing dye may be used without any limit if the maximum absorption wavelength deviates from the recording wavelength adopted individually and specifically by 14 nm or more to the high wavelength side or low wavelength side. In relation to the recording wavelength, it is particularly preferable to select and use a compound having high improvement in sensitivity.

For example, as the red recording wavelength, 647.1 nm or 633 nm is often used. In the case of using such a red recording wavelength, particularly, a compound (1) or (2) represented by the following formula is preferably used from the viewpoint of sensitivity improvement. 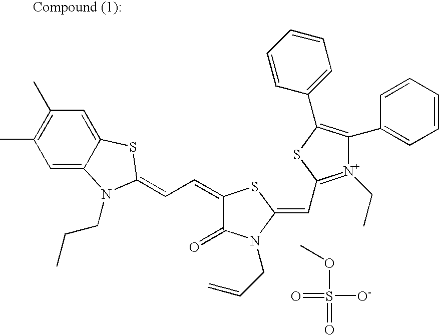
Chemical name: 2-[[3-allyl-5-[2-(5,6-dimethyl-3-propyl-2(3H) -benzothiazolylidene)ethylidene]-4-oxo-2-thiazolidinylidene]methyl]-3-ethyl-4,5-diphenylthiazolium methylsulfate (manufactured by Hayashibara Co., Ltd.); 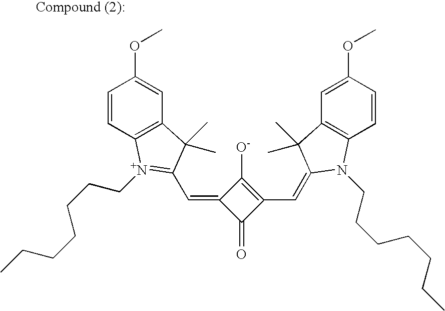
Chemical name: 1-heptyl-2-[3-(1-heptyl-5-methoxy-3,3-dimethyl -1,3-dihydro-indole-2-ilidenemethyl)-2-hydroxy-4-oxo-2-cyclobutenylidenemethyl]-5-methoxy-3,3-dimethyl-3H-indolium inner salt (manufactured by Hayashibara Co., Ltd.).

Also, as the green recording wavelength, 532 nm, 514.5 nm, 553 nm or 560 nm is often used. In the case of performing interference exposure with the use of such a green recording wavelength, particularly, the following compound (3) or (4) is preferably used among the cyclopentanone skeleton containing compounds represented by the general formula (1) from the viewpoint of improvement in sensitivity: 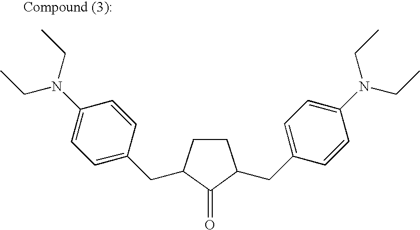
Chemical name: 2,5-bis(4-diethylaminobenzylidene)cyclopentanone (manufactured by Hayashibara Co., Ltd.); 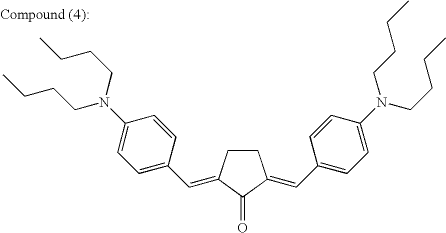
Chemical name: 2,5-bis(4-dibutylaminobenzylidene)cyclopentanone (manufactured by Hayashibara Co., Ltd.).

Furthermore, as the blue recording wavelength, 458 nm, 476 nm or 488 nm is often used. In the case of using such a blue recording wavelength, particularly, the following compound (5) or (6) is preferably used among the above exemplified dyes from the viewpoint of improvement in sensitivity: 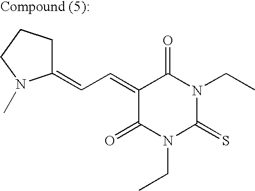
Chemical name: 1,3-diethyl-5-[2-(1-methyl-pyrrolidine-2-ilidene)-ethylidene]-2-thioxo-dihydro-pyrimidine-4,6-dione (manufactured by Hayashibara Co., Ltd.); 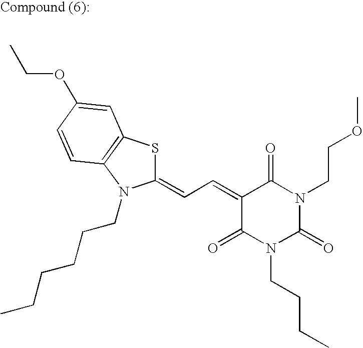
Chemical name: 1-butyl-5-[2-(6-ethoxy-3-hexyl-3H-benzothiazole -2-ilidene)-ethylidene]-3-(2-methoxy-ethyl)-pyrimidine -2,4,6-trione (manufactured by Hayashibara Co., Ltd.).

The sensitizing dye may be used one kind or in a mixture of two or more kinds.

The photopolymerizable compound is a component (refractive index modulation component) which is unevenly distributed on a strongly exposed portion in high concentration due to the diffusion and movement when the hologram recording portion comprising the composition for hologram recording is subject to the interference exposure, is fixed by a polymerization reaction, and as a result, causes the refractive index modulation at the strongly exposed portion. By the refractive index modulation, a volume hologram is recorded.

As the photopolymerizable compound, a compound which allows a polymerization or dimerization reaction to proceed by light radiation, and can diffuse and move in the composition for hologram recording can be used. For example, there may be a photopolymerizable compound which allows a reaction to proceed in a reaction form such as a polymerization reaction including a photoradical polymerization, a photocationic polymerization, a photo anionic polymerization or the like, a polymerization which proceeds through photodimerization or the like.

As the photoradical polymerizable compound among the photopolymerizable compounds, a compound having at least one ethylenic unsaturated bond which is capable of addition-polymerization can be exemplified, the example of which may include unsaturated carboxylic acid and a salt thereof, ester of unsaturated carboxylic acid and aliphatic polyalcohol, ester of unsaturated carboxylic acid and an aromatic skeleton-containing polyalcohol, an amide-bonded compound of unsaturated carboxylic acid and an aliphatic polyvalent amine compound and an amide-bonded compound of unsaturated carboxylic acid and an aromatic skeleton-containing polyvalent amine. As a specific example of a monomer of the ester of unsaturated carboxylic acid and aliphatic polyalcohol compound, there may be ethylene glycol di(meth)acrylate, triethylene glycol di(meth)acrylate, 1,3-butanediol di(meth)acrylate, tetramethyleneglycol di(meth)acrylate, propyleneglycol di(meth)acrylate, neopentylglycol di(meth)acrylate, trimethylolpropane tri(meth)acrylate, trimethylolpropane tri((meth)acryloyloxypropyl)ether, trimethylolethane tri(meth)acrylate, hexanediol di(meth)acrylate, 1,4-cyclohexanediol di(meth)acrylate, tetraethylene glycol di(meth)acrylate, pentaerythritol di(meth)acrylate, pentaerythritol tri(meth)acrylate, pentaerythritol tetra(meth)acrylate, dipentaerythritol di(meth)acrylate, dipentaerythritol tri(meth)acrylate, dipentaerythritol tetra(meth)acrylate, dipentaerythritol hexa(meth)acrylate, sorbitol tri(meth)acrylate, sorbitol tetra(meth)acrylate, sorbitol penta(meth)acrylate, sorbitol hexa(meth)acrylate, tri((meth)acryloyloxyethyl) isocyanurate, polyester (meth)acrylate oligomer, 2-phenoxyethyl (meth)acrylate, phenolethoxylate mono(meth)acrylate, 2-(p-chlorophenoxy)ethyl (meth)acrylate, p-chlorophenyl (meth)acrylate, phenyl (meth)acrylate, 2-phenylethyl (meth)acrylate, (2-(meth)acryloxyethyl)ether of bisphenol A, ethoxylated bisphenol A diacrylate, 2-(1-naphthyloxy)ethyl (meth)acrylate, o-biphenyl acrylate, 9,9-bis(4-(meth)acryloxydiethoxyphenyl)fluorene, 9,9-bis(4-(meth)acryloxytriethoxyphenyl)fluorene, 9,9-bis(4-acryloxydipropoxyphenyl)fluorene, 9,9-bis(4-acryloxyethoxy-3-methylphenyl)fluorene, 9,9-bis(4-acryloxyethoxy-3-ethylphenyl)fluorene, 9,9-bis(4-acryloxyethoxy-3,5-dimethyl)fluorene or the like. Also, a sulfur-containing acryl compound disclosed in JP-A No. Sho 61-72748 can be used, for example, 4,4′-bis(β-(meth)acryloyloxyethylthio)diphenylsulfone, 4,4′-bis(β-(meth)acryloyloxyethylthio)diphenylketone, 4,4′-bis(β-(meth)acryloyloxyethylthio)-3,3′, 5,5′-tetrabromodiphenylketone, 2,4-bis(β-(meth)acryloyloxyethylthio)diphenylketone or the like, but may not be limited thereto.

Also, as the photocationic polymerizable compound among the photopolymerizable compounds, there may be cyclic ethers represented by an epoxy ring and an oxetane ring, thioethers or vinyl ethers. As a specific example of the epoxy ring containing compound, there may be polyalkyleneglycoldiglycidyl ether, bisphenol A diglycidyl ether, glycerin triglycidyl ether, diglycerol triglycidyl ether, diglycidyl hexahydrophthalate, trimethylolpropane diglycidyl ether, allyl glycidyl ether, phenyl glycidyl ether, cyclohexeneoxide or the like, but may not be limited thereto.

Furthermore, specifically as the photoanionic polymerizable compound among the photopolymerizable compounds, there may be a vinyl monomer having electron attractivity, that is, a monomer containing an electron attractive group and having an ethylenic double bond having anionic polymerization activity increased by the electron attractive group, can be used. As such a monomer, there may be styrene, methyl α-cyano acrylate, methyl vinyl ketone, acrylonitrile or the like. Also, a monomer having a chemical structure which allows a ring-opening polymerization by an anionic catalyst such as cyclic ethers, lactones, lactams, cyclic urethanes, cyclic ureas, cyclic siloxanes or the like can be accordingly used as the anionic polymerizable compound.

Among the photopolymerizable compounds, the photoradical polymerizable compound and the photocationic polymerizable compound are suitably used since many of the photoradical polymerizable compound and the photocationic polymerizable compound are available and easy to control the reaction.

When a hologram recording material containing two or more kindsof refractive index modulation components having different refractive index and rate of diffusion and movement due to the photopolymerization reaction is subject to the interference exposure, a polymerization reaction of a refractive index modulation component having high rate of diffusion and movement due to the photopolymerization reaction preferentially proceeds at the strongly exposed portion. Thereby, concentration of the refractive index modulation component having high rate of diffusion and movement, and at the same time, a refractive index modulation component having low rate of diffusion and movement due to the photopolymerization reaction is removed from the strongly exposed portion so as to diffuse and move to a weakly exposed portion, in which the refractive index modulation component having low rate of diffusion and movement due to the photopolymerization reaction is polymerized and fixed. As a result, a refractive index difference between the strongly exposed portion and the weakly exposed portion is generated according to the refractive index of each refractive index modulation component of different kind. This is referred as the volume exclusion effect. If the refractive index difference is higher, the diffraction efficiency improves and a bright hologram can be obtained.

For the purpose of increasing diffraction efficiency by such a volume exclusion effect, a second refractive index modulation component, which has a difference of refractive index with respect to the photopolymerizable compound and increases a distribution of the first refractive index modulation component to the strongly exposed portion by the volume exclusion effect upon interference exposure or a refractive index difference between the strongly exposed portion and the weakly exposed portion, may be compounded to the photosensitive composition for volume hologram recording of the present invention.

Herein, in the case that the photopolymerizable compound as the first refractive index modulation component is a high refractive index type refractive index modulation component, the photopolymerizable compound diffuses and moves so as to concentrate in the strongly exposed portion, which thereby becomes a high refractive index, and the second refractive index modulation component removed from the strongly exposed portion, diffuses, moves and concentrates in the weakly exposed portion, which there by becomes a low refractive index. On the other hand, in the case that the photopolymerizable compound as the first refractive index modulation component is a low refractive index type refractive index modulation component, contrary to the above case, the strongly exposed portion becomes a low refractive index since the concentration of the photopolymerizable compound increases, and the weakly exposed portion becomes a high refractive index since the concentration of the second refractive index modulation component increases.

Since the second refractive index modulation component is for facilitating the refractive index distribution generated by uneven distribution of the photopolymerizable compound as the first refractive index modulation component, in the case of using both second refractive index modulation component and binder resin, a compound having the same tendency of magnitude relation as the magnitude relation between the photopolymerizable compound as the first refractive index modulation component and the binder resin is selected as the second refractive index modulation component. That is, in the case that the photopolymerizable compound as the first refractive index modulation component is the high refractive index type, the second refractive index modulation component and the binder resin having lower refractive index than the photopolymerizable compound are used. On the other hand, in the case that the photopolymerizable compound as the first refractive index modulation component is the low refractive index type, the second refractive index modulation component and the binder resin having higher refractive index than the photopolymerizable compound are used. The second refractive index modulation component is preferably a compound having large refractive index difference with respect to the photopolymerizable compound used as the first refractive index modulation component as much as possible.

As the second refractive index modulation component, a compound, from the photopolymerizable compounds, which has a refractive index difference and lower rate of polymerization with respect to the photopolymerizable compound used as the first refractive index modulation component can be used. In this case, both first refractive index modulation component and second refractive index modulation component may have the same reaction form, for example, both are photoradical polymerizable, or may have different reaction form, for example, one is photoradical polymerizable and the other is photocationic polymerizable. Since the photocationic polymerizable compound generally has lower rate of polymerization than the photoradical polymerizable compound, it is suitable to use in a combination of the photoradical polymerizable compound as the first refractive index modulation component and the photocationic polymerizable compound as the second refractive index modulation component.

Also, the composition for hologram recording of the present invention may have a metallic particle, which has a difference of refractive index with respect to the photopolymerizable compound as the first refractive index modulation component compounded, as the second refractive index modulation component.

As the metallic particle, there may be an unreactive metallic particle or a polymerization reactive metallic particle having a photopolymerization reactive group or other reactive group introduced on the particle surface if it is a compound which can diffuse and move in a layer of the volume hologram recording material and has difference with a refractive index of the photopolymerizable compound.

A particle diameter of the metallic particle is preferably the hologram recording wavelength or less, specifically 1 to 700 nm, particularly 5 to 500 nm, from the view point of diffusing and moving ability in the layer of the composition for hologram recording. As the non-photopolymerization reactive metallic particle, for example, there may be titania, zirconia, zinc, indium, tin or the like.

As a method to introduce the photopolymerization reactive group to the metallic particle, there may be a method of coupling treatment to the surface of a metallic particle by a surface treatment such as a dry method, a wet method, a blend method or the like using a photopolymerization reactive coupling agent or the like. Also, as the metallic particle to have the photopolymerization reactive group introduced, for example, there by be titania, zirconia, zinc, indium, tin or the like as mentioned above. The photopolymerization reactive group to be introduced may be the same polymerizable reaction group as that of the photopolymerizable compound, that is, a group which allows a reaction to proceed in a reaction form such as a polymerization reaction including a photoradical polymerization, a photocationic polymerization or a photoanionic polymerization or a polymerization through a photodimerization or the like.

The photo polymerization initiator is used by accordingly being selected from a photoradical polymerization initiator, a photocationic polymerization initiator, a photoanionic polymerization initiator or the like in accordance with the reaction form of the photopolymerizable compound.

As the photoradical polymerization initiator, there may be an imidazole derivative, a bisimidazole derivative, a N-arylglycine derivative, an organic azide compound, titanocenes, an aluminate complex, an organic peroxide, a N-alkoxypyridinium salt, a thioxanthone derivative or the like. Specifically, 1,3-di(tert-butyldioxycarbonyl)benzophenone, 3,3′, 4,4′-tetrakis(tert-butyldioxycarbonyl)benzophenone, 3-phenyl-5-isooxazolone, 2-mercaptobenzoimidazole, bis(2,4,5-triphenyl)imidazole, 2,2-dimethoxy-1,2-diphenylethane-1-one (product name: Irgacure 651, manufactured by Chiba Specialty Chemicals, Inc.), 1-hydroxy-cyclohexyl-phenyl-ketone (product name: Irgacure 184, manufactured by Chiba Specialty Chemicals, Inc.), 2-benzyl-2-dimethylamino-1-(4-morpholinophenyl)-butane-1-one (product name: Irgacure 369, manufactured by Chiba Specialty Chemicals, Inc.), bis(η⁵-2,4-cyclopentadiene-1-yl)-bis (2,6-difluoro-3-(1H-pyrrole-1-yl)-phenyl)titaniuim) (product name: Irgacure 784, manufactured by Chiba Specialty Chemicals, Inc.) or the like, but may not be limited thereto.

As the photocationic polymerization initiator, there may be sulfonic ester, imide sulfonate, dialkyl-4-hydroxy sulfonium salt, aryl sulfonate-p-nitrobenzyl ester, a silanol-aluminum complex, (η⁶-benzene) (η⁵-cyclopentadienyl) iron (II) or the like. Specifically, there may be benzointosilate, 2,5-dinitrobenzyltosilate, N-tosilphthalic imide or the like, but may not be limited thereto.

A compound which can be used as the photoradical polymerization initiator as well as the photocationic polymerization initiator, an aromatic iodonium salt, anaromatic sulfonium salt, an aromatic diazonium salt, an aromatic phosphonium salt, a triazine compound, an iron arene complex or the like. Specifically, an iodonium salt such as a chloride, bromide, fluoroborate salt, hexafluorophosphate salt, hexafluoroantimonate salt or the like of iodonium including diphenyliodonium , ditolyliodonium bis(p-tert-butylphenyl) iodonium, bis(p-chlorophenyl) iodonium or the like; a sulfonium salt such as a chloride, bromide, fluoroborate salt, hexafluorophosphate salt, hexafluoroantimonate salt or the like of sulfonium including triphenyl sulfonium, 4-tert-butyltriphenyl sulfonium, tris(4-methylphenyl) sulfonium or the like; a 2,4,6-substituted-1,3,5 triazine compound such as 2,4,6-tris(trichloromethyl)-1,3,5-triazine, 2-phenyl-4,6-bis(trichloromethyl)-1,3,5-triazine, 2-methyl-4, 6-bis (trichloromethyl)-1,3,5-triazine or the like, but may not be limited thereto.

In the case of using such an initiator which functions to both photoradical polymerization and photocationic polymerization, only one kind of the photopolymerization initiator may be compounded in the composition for hologram recording, and the photoradical polymerizable compound and the photocationic polymerizable compound may be compounded in combination as the photopolymerizable compounds.

As the photoanionic polymerization initiator, for example, there may be a compound which generates amine by ultraviolet irradiation, specifically, 1,10-diaminodecane, 4,4′-trimethylenedipiperidine, carbamates and a derivative thereof, a cobalt-amine complex, aminooxyimides, ammonium borates or the like. As a commercially available product, NBC-101 (product name, manufactured by Midori Kagaku Co., Ltd.) can be exemplified.

The photopolymerization initiator is preferably subject to a decomposition treatment after the hologram recording from the viewpoint of stability of a recorded hologram. For example, organic peroxides are preferable since the initiator is easily decomposed by ultraviolet irradiation.

In the case of using the cyclopentanone skeleton containing compound represented by the aforementioned general formula (1) as the sensitizing dye, it is preferable to use the diaryliodonium salt among the above examples, particularly, a compound containing diaryliodonium skeleton represented by the following general formula (2), in combination since the effect to improve sensitivity is high: 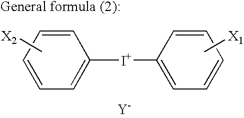
wherein, each of X₁, and X₂ is independently an alkyl group having 1 to 20 carbons, halogen or an alkoxy group having 1 to20 carbons; “Y⁻” is a monovalent anion.

As a specific example of X₁ and X₂, there may be methyl, ethyl, n-propyl, t-butyl, F, Cl, Br, a methoxy group or the like. As “Y⁻”, which is a monovalent anion, may be any anion which functions as a counter ion. Specifically, there may be I⁻, BF₄⁻, PF₆⁻, SbF₆⁻, CF₃SO₃⁻, AsF₆⁻, or (C₆F₅)₄B⁻or the like.

In the composition for hologram recording of the present invention, a binder resin may be compounded. By compounding the binder resin, it becomes easier to form a layer of volume hologram recording which is not flowable on a substrate, and the composition can be utilized as a dry developing type hologram forming material.

If the composition for hologram recording of the present invention without the binder resin compounded thereby has too high flowability, a volume hologram can be recorded in such a manner that the layer of the composition for hologram recording is formed by a suitable method such as inserting the composition between transparent substrates such as glass or the like followed by interference exposure, and, if required, the layer is cured by a photo- or heat-curing or other reaction.

In order to increase diffraction efficiency, it is preferable to use a binder resin having a large refractive index difference with respect to the photopolymerizable compound, which is the refractive index modulation component. When the diffraction efficiency is larger, a visually bright and excellent hologram can be obtained.

The binder resin may be or may not be polymerization reactive. However, the polymerization reactive binder resin is preferable since physical properties such as strength, heat resistance or the like of the coating layer of the photosensitive medium for volume hologram recording or the volume hologram using the photosensitive composition for volume hologram recording of the present invention can improve.

As the binder resin, a thermoplastic resin may be used. Specifically, there may be poly (meth) acrylic ester or a partial hydrolyzate thereof, polyvinyl acetate or a hydrolyzate thereof, polyvinyl alcohol or a partially acetalized product thereof, triacetyl cellulose, polyisoprene, polybutadiene, polychloroprene, silicone rubber, polystyrene, polyvinyl butyral, polyvinyl chloride, polyallylate, chlorinated polyethylene, chlorinated polypropylene, poly-N-vinylcarbazole or a derivative thereof, poly-N-vinylpyrrolidone or a derivative thereof, a copolymer of styrene and maleic anhydride or a half ester thereof, a copolymer containing at least one polymerization component selected from the group consisting of copolymerizable monomers such as (meth)acrylic acid, (meth)acrylic ester, acrylamide, acrylonitrile, ethylene, propylene, vinyl chloride and vinyl acetate or mixtures thereof and so on.

As the polymerization reactive binder resin, an organic-inorganic hybrid resin utilizing a sol-gel reaction or a thermosetting compound such as an oligomer type thermosetting resin or the like can be used.

As the organic-inorganic hybrid resin, for example, there may be an organic-inorganic hybrid polymer such as a copolymer of an organometallic compound having a polymerizable group represented by the following general formula (3) and a vinyl monomer or the like:
RmM(OR′)n General formula (3):
wherein, “M” is a metal selected from the group consisting of Si, Ti, Zr, Zn, In, Sn, Al, Se and the like; “R” is a vinyl group or a (meth)acryloyl group having 1 to 10 carbons; “R′” is an alkyl group having 1 to 10 carbons; and “m+n” is a valence of the metal “M”.

As an example of a compound when the metal atom “M” is Si, there may be vinyltriethoxysilane, vinylmethoxysilane, vinyltributoxysilane, vinyltriallyloxysilane, vinyltetraethoxysilane, vinyltetramethoxysilane, (meth) acryloxypropyltrimethoxysilane or the like.

As the vinyl monomer used for the organic-inorganic hybrid polymer, there may be (meth) acrylic acid or (meth) acrylic acid ester, but may not be limited thereto.

Among the organic-inorganic hybrid resins, an organometallic compound represented by the following general formula (4) is particularly effective to further increase the refractive index difference between the binder resin and the photopolymerizable compound since it has smaller molecular weight than the above-mentioned organic-inorganic hybrid polymer which is already polymerized and the effect to increase cross-linking density is high:
M′(OR″)n′ General formula (4)
wherein, “M′” is a metal selected from the group consisting of Ti, Zr, Zn, In, Sn, Al, Se and the like; “R′′” is an alkyl group having 1 to 10 carbons; and “n′” is a valence of the metal “M′”.

Adding the organometallic compound represented by the general formula (4) to the photosensitive composition for volume hologram recording has effect not only to increase the refractive index of the binder but to improve toughness and heat resistance of the layer since a network structure is formed with the above-mentioned binder resin in the presence of water and an acidic catalyst by a sol-gel reaction. As the metal “M′”, a metal having refractive index as high as possible may be preferably used in order to increase the refractive index difference between the binder resin and the photopolymerizable compound.

As the oligomer type thermosetting resin, for example, there may be a thermosetting epoxy compound produced by a condensation reaction between a phenol compound selected from various kinds such as bisphenol A, bisphenol S, novolac, o-cresol novolac, p-alkylphenol novolac and the like and epichlorohydrin can be used.

The thermosetting epoxy compound functions as a binder since it is an oligomer which forms crosslinking, and also functions as the second refractive index modulation component since it is photocationic polymerization reactive and has a molecular size capable of diffusing and moving in the composition. Hence, the thermosetting epoxy compound can be compounded to the composition for hologram recording instead of other binder resin or together with other binder resin.

The hologram recording portion containing the photosensitive composition for volume hologram recording having the thermosetting epoxy compound compounded is fixed by a heat treatment after the interference exposure, and the cationic polymerizable compound is crosslinked by the strong acid produced upon the interference exposure so as to increase the refractive index. Thereby, the refractive index modulation is increased. Also, due to the crosslinked structure, the effect to increase resistance such as heat resistance, weather resistance or the like or mechanical strength is high.

As the binder resin, it is further preferable to use a binder resin which can form a covalent bond with the photoreactive group of the photopolymerizable compound. In this case, when an unreacted photopolymerizable compound or a polymer of photopolymerizable compound is subject to a covalent bond with the binder resin in a predetermined reaction form after the interference exposure, a stable bond is produced between the photopolymerizable compound and the binder resin, thereby, a hologram layer excellent in layer strength, heat resistance, fixing ability of hologram or the like can be obtained.

It is preferable to introduce a functional group photoreactive or thermally polymerizable with the photoreactive group of the photopolymerizable compound in the binder resin as a functional group which can form the above-mentioned covalent bond. The a hologram recording portion containing the photopolymer type hologram recording material is often subject to exposure or heating uniformly on the whole surface after the interference exposure process in order to promote the refractive index modulation or to complete the polymerization reaction. It is preferable that the functional group of the binder resin is capable of photopolymerization or thermal polymerization with the photopolymerizable group of the photopolymerizable compound since the process of exposuring or heating the whole surface of the hologram recording portion containing the photosensitive composition for hologram recording after the interference exposure in order to promote refractive index modulation or to fix the hologram, and the process of copolymerizing the binder resin with the photopolymerizable compound or a polymer thereof in order to improve the layer strength or resistance of the hologram recording portion can be combined in one process by a common reaction form.

Particularly preferably, a functional group which can photopolymerize with the photoreactive group of the photopolymerizable compound maybe introduced to the binder resin. For example, in the case that the photopolymerizable compound has an ethylenic unsaturated bond capable of addition-polymerization as the photoreactive group, similarly, a binder resin having an ethylenic unsaturated bond (preferably, an ethylenic double bond) capable of addition-polymerization such as an acryloyl group, a methacryloyl group or the like is used. Also, in the case that the photopolymerizable compound has a photocationic polymerizable group such as an epoxy group or the like, a binder resin having a functional group polymerizable with the photocationic polymerizable group upon the interference exposure is used. As the functional group polymerizable with the photocationic polymerizable group upon the interference exposure includes a photocationic polymerizable group such as an epoxy group, a vinyl ether group or the like itself as well as, for example, a functional group such as a hydroxyl group, a carboxyl group or the like.

When the above-mentioned particularly preferable combination is used, the photopolymerizable compound in the strongly exposed portion not only polymerizes with the adjacent photopolymerizable compound but also polymerizes with the peripheral binder resin when the hologram recording portion is subject to the interference exposure. Therefore, there is also an effect that sensitivity of the interference exposure and the amount of refractive index modulation improve even if the reactivity increases. Also in this case, there is the effect that the refractive index modulation is promoted or the polymerization reaction is completed so as to form a hologram and also the covalent bond between the binder resin and the photopolymerizable compound is further produced so as to provide excellent physical properties of the coating layer such as layer strength, heat resistance or the like to the layer of hologram recording material by general exposure or heating uniformly on the whole surface after the interference exposure.

As the binder resin, one kind selected from various materials including the above exemplified materials can be used, or in combination of two or more kinds.

If the composition for hologram recording of the present invention contains the binder resin, the sensitizing dye may preferably be used in the ratio of 0.01 to 20 parts by mass, more preferably 0.01 to 2 parts by mass, with respect to the binder resin of 100 parts by mass.

The photopolymerizable compound may be preferably used in the ratio of 10 to 1000 parts by mass, more preferably 10 to 100 parts by mass, with respect to the binder resin of 100 parts by mass.

The photopolymerization initiator may be preferably used in the ratio of 0.1 to 20 parts by mass, more preferably 5 to 15 parts by mass, with respect to the binder resin of 100 parts by mass.

The thermosetting epoxy compound may be preferably used in the ratio of 10 to 300 parts by mass, more preferably 70 to 150 parts by mass, with respect to the binder resin of 100 parts by mass.

If the a composition for hologram recording of the present invention does not contain the binder resin, the compounding amount of the sensitizing dye, the photopolymerizable compound, the photopolymerization initiator and the thermosetting epoxy compound may be in the range of the above-mentioned compounding amount of each component with respect to the binder resin of 100 parts by mass.

Also, other than the above components, various additives such as a plasticizer, an adhesion control agent (an adhesion imparting agent), an antioxidant or the like may be accordingly compounded in the composition for hologram recording in accordance with the purpose.

By dissolving the above components in acetone, methyl ethyl ketone, methyl isobutyl ketone, cyclohexanone, benzene, toluene, xylene, chlorobenzene, tetrahydrofuran, methylcellosolve, ethylcellosolve, methylcellosolve acetate, ethylcellosolve acetate, ethyl acetate, 1,4-dioxane, 1,2-dichloroethane, dichloromethane, chloroform, methanol, ethanol, isopropanol or the like, or a mixed solvent thereof, a coating liquid can be prepared as the composition for hologram recording of the present invention. If the compounding components other than the solvent are also in liquid state at ordinary temperature, the amount of the coating solvent to be used can be reduced or a coating solvent may be not necessary at all.

By coating the above-mentioned coating liquid on an appropriate support such as a substrate film or the like by a method such as spin coating, gravure coating, comma coating, bar coating or the like followed by drying, a layer of the photosensitive composition for volume hologram recording (hereinafter, it may be referred as a hologram recording composition layer) is formed. Thereby, a photosensitive medium for volume hologram recording can be obtained. A thickness of the hologram recording composition layer may be 1 to 100 μm, preferably 2 to 40 μm.

If the flowability of the composition for hologram recording is high, the hologram recording portion may be formed by filling a gap formed by disposing a support and a transparent covering material such as a transparent substrate, a plastic film or the like to face each other with the composition for hologram recording.

As the substrate film of the photosensitive medium for volume hologram recording, there may be a resin having transparency such as a polyethylene film, a polypropylene film, a polyethylene fluoride film, a polyvinylidene fluoride film, a polyvinyl chloride film, a polyvinylidene chloride film, an ethylene-vinyl alcohol film, a polyvinyl alcohol film, a polymethyl methacrylate film, a polyethersulfone film, a polyether etherketone film, a polyamide film, a tetrafluoroethylene-perfluoroalkylvinyl ether copolymerized film, a polyester film such as a polyethylene terephthalate film or the like, a polyimide film or the like. A thickness may be generally 2 to 200 μm, preferably 10 to 50 μm.

If the hologram recording composition layer after drying is adhesive, the film exemplified as the substrate film can be laminated to be a protective film. In this case, a contacting surface of the laminated film and the hologram recording composition layer may be subject to a releasing treatment so as to be easily peeled later.

The thus obtained photosensitive medium for volume hologram recording has the hologram recording portion containing the composition for hologram recording on the support. The hologram recording portion generally is a hologram recording composition layer having a constant thickness. However, there may be any embodiment capable of hologram recording. A form or thickness may not be limited. It is not necessary that the thickness is constant. There may be an embodiment in which the composition in a flowing state is filled as aforementioned.

A volume hologram can be formed in the photosensitive medium for volume hologram recording of the present invention by the interference exposure using a conventionally known means.

For example, if required, after preliminarily polymerizing the photopolymerizable compound by radiating the hologram recording material layer of the photosensitive medium for volume hologram recording with relatively weak uniform light, an original plate of hologram is faced to adhere, and then, interference exposure is performed from the transparent substrate film side using a recording light in a visible region, thereby a volume hologram is formed.

As a light source of the recording light having high coherence in a visible region, visible laser light is suitable. For example, the laser light may be selected and used from the group consisting of argon ion laser (458 nm, 488 nm and 514.5 nm), krypton ion laser (647.1 nm), helium-neon laser (633 nm), YAG laser (532 nm), Dye laser (553 nm) and so on.

In the present invention, a spectral absorption property of the hologram recording portion of the photosensitive medium for volume hologram recording is adjusted in accordance with a recording wavelength set individually and specifically. That is, a volume hologram recording system comprising the photosensitive medium for volume hologram recording, in which the hologram recording portion containing the photosensitive composition for volume hologram recording of the present invention is formed on the support, and an optical system, in which the hologram recording portion of the photosensitive medium for volume hologram recording is subject to the interference exposure at a predetermined recording wavelength in a visible region, wherein the maximum absorption wavelength of the sensitizing dye contained in the hologram recording portion is deviated from the predetermined recording wavelength by 14 nm or more and the hologram recording portion itself has absorption at the predetermined recording wavelength, can be formed.

A recording mechanism when the composition for hologram recording of the present invention is used can be presumed to be basically the same as the conventional mechanism. That is, the hologram recording portion containing the composition for hologram recording is subject to the interference exposure, and photopolymerization is caused preferentially in a part strongly radiated with light of the hologram recording portion. Accordingly, concentration gradient of the photopolymerizable compound is generated so that the photopolymerizable compound diffuses and moves from the weakly exposed portion to the strongly exposed portion. As a result, in accordance with the strength of light of the interferential light, difference in density of the photopolymerizable compound is caused, thereby, the difference of refractive index is exhibited.

Herein, in the case that the composition for hologram recording contains the binder resin, when the hologram recording portion is subject to the interference exposure, the concentration of the binder resin becomes high in the weakly exposed portion, and the refractive index approaches that of the binder resin itself. On the other hand, the concentration of the photopolymerizable compound or a polymer thereof becomes high in the strongly exposed portion, and the refractive index approaches that of the photopolymerizable compound itself. Therefore, if the refractive index of the photopolymerizable compound is higher than that of the binder resin, the refractive index increases in the part having higher exposuring strength. If the refractive index of the photopolymerizable compound is lower than that of the binder resin, the refractive index decreases in the part having higher exposuring strength. The refractive index difference becomes an interference fringe, thereby, a volume hologram is formed.

In the present invention, it is presumed that, according to such a hologram recording mechanism, excellent sensitivity and hologram recording performance can be obtained since the possibility of the sensitizing dye to be excited to an appropriate energy level, in which it is much easier to transmit activation energy to the initiator more effectively, significantly improves with the use of the sensitizing dye in which the maximum absorption wavelength of the dye deviates from the recording wavelength by 14 nm or more.

As a result, diffraction efficiency can be increased and a visually bright, excellent hologram can be formed.

Further, if required, it is preferable to perform one or more treatments selected from the group consisting of an expansion treatment for the purpose of tuning the hologram reproducing wavelength or making half-bandwidth of a peak diffraction wavelength wider in a transmittance curve, uniformly exposuring the whole surface by light radiation and a heat treatment after the interference exposure, in an appropriate order since polymerization reaction of an unreacted photopolymerizable compound can be promoted, further the refractive index modulation amount (Δn) can be increased, and also the photopolymerization initiator and the sensitizing dye can be dereactivated so that resistance such as heat resistance, moisture resistance or the like of the volume hologram can be improved.

It is not necessary that the uniform light radiation after the interference exposure is in a visible light region but may be an ultraviolet radiation, for example, a light source such as a super high-pressure mercury lamp, a high-pressure mercury lamp, a carbon arc, a xenon arc, a metal halide lamp or the like is used so that the total exposuring amount is generally about 0.1 to 10,000 mJ/cm², preferably 10 to 4,000 mJ/cm².

If the heat treatment is performed after the interference exposure, the heat treatment may be performed instead of the uniform light radiation or before or after the uniform light radiation. As a phase separation is enhanced by the heat treatment, the photoreactive component which is not polymerized in the photosensitive composition for hologram recording diffuses and moves and the polymerization completes. Thereby, the refractive index modulation amount (Δn) increases and the photosensitive composition for hologram recording is fixed. Also, since the solvent vaporizes, the refractive index modulation amount (Δn) further increases and the resistance such as heat resistance, moisture resistance or the like of the volume hologram can be improved similarly as exposuring ultraviolet ray on the whole surface. The heat treatment is generally performed at 40° C. to 50° C., preferably40 to 100° C., and generally for 5 to 120 minutes, preferably 5 to 30 minutes.

As aforementioned, the hologram is formed by generating the interference fringe by the interference exposure in the hologram recording portion of the photosensitive medium for hologram recording, thus a volume hologram is obtained. According to the present invention, a volume hologram having a diffraction efficiency of 80% or more, preferably 90% or more, can be produced.

### EXAMPLES

Next, the present invention will be explained based on Examples.

1. Producing a volume hologram

### Example 1

(1) Preparing a Photosensitive Composition for Volume Hologram Recording

The following components were mixed to obtain a photosensitive composition for volume hologram recording.

<Composition>

Polyvinyl acetate (manufactured by Sowa Kagaku K. K.; weight average molecular weight: 100,000): 100 parts by mass
9,9-Bis(4-acryloxydiethoxyphenyl)fluorene (product name: BPEFA; manufactured by Osaka Gas Co., Ltd.): 80 parts by mass
Diaryliodonium salt (product name: PI2074; manufactured by Rhodia): 5 parts by mass
2-[[3-allyl-5-[2-(5,6-dimethyl-3-propyl-2(3H) -benzothiazolylidene)ethylidene]-4-oxo-2-thiazolidinylidene]methyl]-3-ethyl-4,5-diphenylthiazolium methylsulfate (the aforementioned compound (1); manufactured by Hayashibara Co., Ltd; the maximum absorption wavelength (λₘₐₓ): 602.5 nm): 1 part by mass
1, 6-Hexanediol diglycidyl ether (product name: EX-212; manufactured by Nagase ChemteX Corporation): 70 parts by mass
Toluene: 30 parts by mass
Methyl ethyl ketone: 30 parts by mass
   (2) Producing a Photosensitive Medium for Volume Hologram Recording

The photosensitive composition for volume hologram recording was coated on a polyethyleneterephthalate (hereinafter referred as “PET”) film (product name: Lumirror T-60; manufactured by Toray Industries, Inc.) having a thickness of 50 μm by means of a bar coater to form a hologram recording composition layer having a thickness of 10 μm after drying, thus produced a photosensitive medium for volume hologram recording.

(3) Producing a Volume Hologram

The hologram recording composition layer side of the photosensitive medium for volume hologram recording was laminated on a mirror. Interference exposure was performed by krypton ion laser light of 647.1 nm entering from the PET film side, thereby, a volume hologram was recorded.

Next, an interference fringe was fixed by heating and ultraviolet irradiation, thus obtained a volume hologram.

### Example 2

Except that the composition of the photosensitive composition for volume hologram recording was changed to the following, a volume hologram was produced under the same condition as Example 1.

<Composition>

Polyvinyl acetate (manufactured by Sowa Kagaku K. K.; weight average molecular weight: 100,000): 100 parts by mass
9,9-Bis(4-acryloxydiethoxyphenyl)fluorene (product name: BPEFA; manufactured by Osaka Gas Co., Ltd.): 80 parts by mass
Diaryliodonium salt (product name: PI2074; manufactured by Rhodia): 5 parts by mass
1-Heptyl-2-[3-(1-heptyl-5-methoxy-3,3-dimethyl-1,3-dihydro-indole-2-ilidenemethyl)-2-hydroxy-4-oxo-2-cyclobutenylidenemethyl]-5-methoxy-3,3-dimethyl-3H-indolium inner salt (the above-mentioned compound(2); manufactured by Hayashibara Co., Ltd., λₘₐₓ: 662 nm): 1 part by mass
1, 6-Hexanediol diglycidyl ether (product name: EX-212; manufactured by Nagase ChemteX Corporation): 70 parts by mass
Toluene: 30 parts by mass
Methyl ethyl ketone: 30 parts by mass

### Example 3

Except that the composition of the photosensitive composition for volume hologram recording was changed to the following and the light source for hologram recording was changed to YAG laser light of 532 nm, a volume hologram was produced under the same condition as Example 1.

<Composition>

Polyvinyl acetate (manufactured by Sowa Kagaku K. K., weight average molecular weight: 100,000): 100 parts by mass
9,9-Bis(4-acryloxydiethoxyphenyl)fluorene (product name: BPEFA; manufactured by Osaka Gas Co., Ltd.): 80 parts by mass
Diaryliodonium salt (product name: PI2074; manufactured by Rhodia): 5 parts by mass
2,5-Bis(4-diethylaminobenzylidene)cyclopentanone (the above-mentioned compound (3); manufactured by Hayashibara Co., Ltd.; the maximum absorption wavelength (λₘₐₓ): 479.5 nm): 1 part by mass
1,6-Hexanediol diglycidyl ether (product name: EX-212; manufactured by Nagase ChemteX Corporation): 70 parts by mass
Toluene: 30 parts by mass
Methyl ethyl ketone: 30 parts by mass

### Example 4

Except that the composition of the photosensitive composition for volume hologram recording was changed to the following and the light source for hologram recording was changed to YAG laser light of 532 nm, a volume hologram was produced under the same condition as Example 1.

<Composition>

Polyvinyl acetate (manufactured by Sowa Kagaku K. K., weight average molecular weight: 100,000): 100 parts by mass
9,9-Bis(4-acryloxydiethoxyphenyl)fluorene (product name: BPEFA; manufactured by Osaka Gas Co., Ltd.): 80 parts by mass
Diaryliodonium salt (product name: PI2074; manufactured by Rhodia): 5 parts by mass
2,5-Bis(4-dibutylaminobenzylidene)cyclopentanone (the above-mentioned compound (4); manufactured by Hayashibara Co., Ltd.; the maximum absorption wavelength (λₘₐₓ): 483 nm): 1 part by mass
1,6-Hexanediol diglycidyl ether (product name: EX-212; manufactured by Nagase ChemteX Corporation): 70 parts by mass
Toluene: 30 parts by mass
Methyl ethyl ketone: 30 parts by mass

### Example 5

Except that the composition of the photosensitive composition for volume hologram recording was changed to the following and the light source for hologram recording was changed to argon ion laser light of 458 nm, a volume hologram was produced under the same condition as Example 1.

<Composition>

Polyvinyl acetate (manufactured by Sowa Kagaku K. K., weight average molecular weight: 100,000): 100 parts by mass
9,9-Bis(4-acryloxydiethoxyphenyl)fluorene (product name: BPEFA; manufactured by Osaka Gas Co., Ltd.): 80 parts by mass
Diaryliodonium salt (product name: PI2074; manufactured by Rhodia): 5 parts by mass
1,3-Diethyl-5-[2-(1-methyl-pyrrolidine-2-ilidene) -ethylidene]-2-thioxo-dihydro-pyrimidine-4,6-dione (the above-mentioned compound (5); manufactured by Hayashibara Co., Ltd.; the maximum absorption wavelength (λₘₐₓ): 437.5 nm): 1 part by mass
1,6-Hexanediol diglycidyl ether (product name: EX-212; manufactured by Nagase ChemteX Corporation): 70 parts by mass
Toluene: 30 parts by mass
Methyl ethyl ketone: 30 parts by mass

### Example 6

Except that the composition of the photosensitive composition for volume hologram recording was changed to the following and the light source for hologram recording was changed to argon ion laser light of 458 nm, a volume hologram was produced under the same condition as Example 1.
   <Composition>
Polyvinyl acetate (manufactured by Sowa Kagaku K. K., weight average molecular weight: 100,000): 100 parts by mass
9,9-Bis(4-acryloxydiethoxyphenyl)fluorene (product name: BPEFA; manufactured by Osaka Gas Co., Ltd.): 80 parts by mass
Diaryliodonium salt (product name: PI2074; manufactured by Rhodia): 5 parts by mass
1-Butyl-5-[2-(6-ethoxy-3-hexyl-3H-benzothiazole -2-ilidene)-ethylidene]-3-(2-methoxy-ethyl)-pyrimidine-2,4,6 trione (the above-mentioned compound (6); manufactured by Hayashibara Co., Ltd.; the maximum absorption wavelength (λₘₐₓ): 489.5 nm): 1 part by mass
1,6-Hexanediol diglycidyl ether (product name: EX-212; manufactured by Nagase ChemteX Corporation): 70 parts by mass
Toluene: 30 parts by mass
Methyl ethyl ketone: 30 parts by mass

### (Comparative example 1)

Except that the composition of the photosensitive composition for volume hologram recording was changed to the following, it was attempt to produce a volume hologram under the same condition as Example 1. However, since the initiator was not sufficiently activated for recording by the sensitizing dye, the interference fringe was not recorded by the photopolymerizable compound. Hence, a hologram was not able to produce.

<Composition>

Polyvinyl acetate (manufactured by Sowa Kagaku K. K., weight average molecular weight: 100,000): 100 parts by mass
9,9-Bis(4-acryloxydiethoxyphenyl)fluorene (product name: BPEFA; manufactured by Osaka Gas Co., Ltd.): 80 parts by mass
Diaryliodonium salt (product name: PI2074; manufactured by Rhodia): 5 parts by mass
Dibutyl-{4-[3-(4-dibutylamino-phenyl)-2-hydroxy -4-oxo-2-cyclobutenylidene]-cyclohexa-2,5-dienylidene}-ammonium inner salt (a compound (7) represented by the following formula; manufactured by Hayashibara Co., Ltd.; the maximum absorption wavelength (λₘₐₓ): 649 nm): 1 part by mass 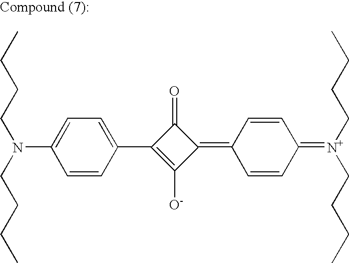
1, 6-Hexanediol diglycidyl ether (product name: EX-212; manufactured by Nagase ChemteX Corporation): 70 parts by mass
Toluene: 30 parts by mass
Methyl ethyl ketone: 30 parts by mass

### (Comparative example 2)

Except that the composition of the photosensitive composition for volume hologram recording was changed to the following and the light source for hologram recording was changed to YAG laser light of 532 nm, it was attempt to produce a volume hologram under the same condition as Example 1. However, since the initiator was not sufficiently activated for recording by the sensitizing dye, the interference fringe was not recorded by the photopolymerizable compound. Hence, a hologram was not able to produce.

<Composition>

Polyvinyl acetate (manufactured by Sowa Kagaku K. K., weight average molecular weight: 100,000): 100 parts by mass
9,9-Bis(4-acryloxydiethoxyphenyl)fluorene (product name: BPEFA; manufactured by Osaka Gas Co., Ltd.): 80 parts by mass
Diaryliodonium salt (product name: PI2074; manufactured by Rhodia): 5 parts by mass
2-[2-(4-dimethylamino-phenyl)-vinyl]-3-octyl-3-benzothiazolium bromide (a compound (8) represented by the following formula, manufactured by Hayashibara Co., Ltd.; the maximum absorption wavelength (λₘₐₓ): 528 nm): 1 part by mass 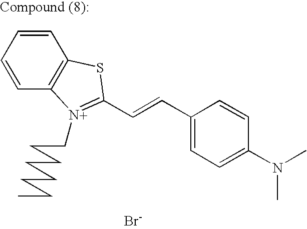
1,6-Hexanedioldiglycidylether (product name: EX-212; manufactured by Nagase ChemteX Corporation): 70 parts by mass
Toluene: 30 parts by mass
Methyl ethyl ketone: 30 parts by mass

### Comparative example 3

Except that the composition of the photosensitive composition for volume hologram recording was changed to the following and the light source for hologram recording was changed to argon ion laser light of 458 nm, it was attempt to produce a volume hologram under the same condition as Example 1. However, since the initiator was not sufficiently activated for recording by the sensitizing dye, the interference fringe was not recorded by the photopolymerizable compound. Hence, a hologram was not able to produce.

<Composition>

Polyvinyl acetate (manufactured by Sowa Kagaku K. K., weight average molecular weight: 100,000): 100 parts by mass
9,9-Bis(4-acryloxydiethoxyphenyl)fluorene (product name: BPEFA; manufactured by Osaka Gas Co., Ltd.): 80 parts by mass
Diaryliodonium salt (product name: PI2074; manufactured by Rhodia): 5 parts by mass
2-[2-(4-dimethylamino-phenyl)-vinyl]-3,5-dimethyl -3-oxazolium iodide (a compound (9) represented by the following formula; manufactured by Hayashibara Co., Ltd.; the maximum absorption wavelength (λₘₐₓ): 459 nm): 1 part by mass 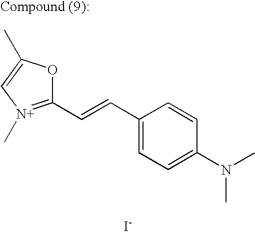
1,6-Hexanediol diglycidyl ether (product name: EX-212; manufactured by Nagase ChemteX Corporation): 70 parts by mass
Toluene: 30 parts by mass
Methyl ethyl ketone: 30 parts by mass
   2. Evaluation of Hologram Recording Performance
   (1) The Maximum Absorption Wavelength of Sensitizing Dye and Absorption of Composition at Recording Wavelength

After the photosensitive composition for volume hologram recording obtained in each Example or Comparative example was coated on a PET film (product name: Lumirror T-60; manufactured by Toray Industries, Inc.) having a thickness of 50 μm to form a hologram recording composition layer having a thickness of 10 μm after drying, the maximum absorption wavelength of sensitizing dye was measured by means of a spectrometer (product name: UVPC-3100; manufactured by Shimadzu Corporation). At the same time, it was confirmed if the hologram recording composition layer has absorption at the recording wavelength.

(2) Diffraction Efficiency

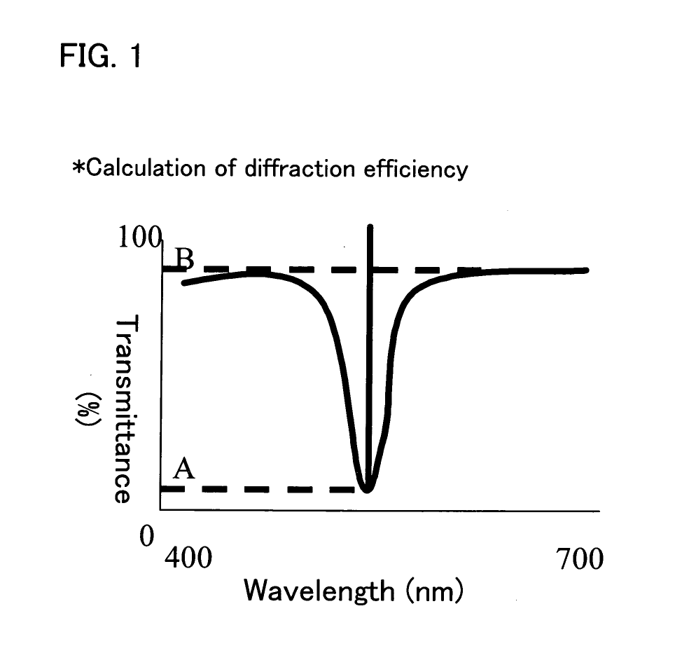

Transmittance was measured by means of a spectrometer (product name: UVPC-3100; manufactured by Shimadzu Corporation) Diffraction efficiency η=|A-B|/B was calculated when the peak transmittance was referred as “A” and the base transmittance was referred as “B” in the obtained spectral transmittance curve (see FIG. 1).

(3) Evaluation Result

Table 1 and Table 2 show diffraction efficiency of volume hologram produced in each Example or Comparative example, and also the recording wavelength, the sensitizing dye, the maximum absorption wavelength (λₘₐₓ) of the sensitizing dye, difference between the recording wavelength and λₘₐₓ, absorption at the recording wavelength of the composition.

In each Example, a bright hologram having high diffraction efficiency was obtained. On the other hand, in all Comparative examples, a hologram was not able to be produced since the initiator was not sufficiently activated for recording by the sensitizing dye.

TABLE 1

| | | Sensitizing dye | | Difference |
|---|---|---|---|---|
| | | | Maximum | between |
| | Recording | | absorption | recording |
| | wavelength | | wavelength | wavelength |
| | (nm) | Dye | λₘₐₓ (nm) | and λₘₐₓ |
| Example 1 | Red | Compound (1) | 602.5 | 44.6 |
| Example 2 | (647.1) | Compound (2) | 662 | 14.9 |
| Example 3 | Green | Compound (3) | 479.5 | 52.5 |
| Example 4 | (532) | Compound (4) | 483 | 49 |
| Example 5 | Blue | Compound (5) | 437.5 | 20.5 |
| Example 6 | (458) | Compound (6) | 489.5 | 31.5 |
| Comparative | Red | Compound (7) | 649 | 1.9 |
| example 1 | (647.1) | | | |
| Comparative | Green | Compound (8) | 528 | 4 |
| example 2 | (532) | | | |
| Comparative | Blue | Compound (9) | 459 | 1 |
| example 3 | (458) | | | |

TABLE 2

| | | Diffraction |
|---|---|---|
| | Hologram | efficiency η |
| | recording | (%) |
| Example 1 | ∘ | 96 |
| Example 2 | ∘ | 93 |
| Example 3 | ∘ | 88 |
| Example 4 | ∘ | 86 |
| Example 5 | ∘ | 57 |
| Example 6 | ∘ | 60 |
| Comparative | x | — |
| example 1 | | |
| Comparative | x | — |
| example 2 | | |
| Comparative | x | — |
| example 3 | | |

1-8. (canceled)

9. A method of producing a volume hologram, wherein a hologram recording portion comprising a photosensitive composition for volume hologram recording containing a photopolymerizable compound as a refractive index modulation component, a photopolymerization initiator and a sensitizing dye which increases sensitivity of the photopolymerization initiator with respect to a wavelength of a visible region is subject to interference exposure using a predetermined volume hologram recording wavelength set in a visible region so as to record the volume hologram, and wherein the sensitizing dye has absorption at the volume hologram recording wavelength and a maximum absorption wavelength of the sensitizing dye deviates by 14 nm or more from the volume hologram recording wavelength.

10. A method of producing a volume hologram according to claim 9, wherein the photosensitive composition for volume hologram recording further contains a binder resin and/or a thermosetting compound.

11. A method of producing a volume hologram according to claim 9, wherein the photopolymerizable compound is at least one kind selected from the group consisting of a photoradical polymerizable compound and a photocationic polymerizable compound.

12. A method of producing a volume hologram according to claim 9, wherein the photosensitive composition for volume hologram recording further contains a second refractive index modulation component having different refractive index from the photopolymerizable compound.

13. A method of producing a volume hologram according to claim 9, wherein the sensitizing dye is a cyclopentanone skeleton containing compound represented by the following general formula (1): 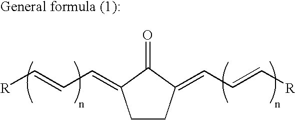
wherein, “R” is a carbon-nitrogen containing substituent represented by “NₓC_{y}” in which x=1 to 4, y=8 to 30; “R” may contain a hydrogen atom and/or a halogen atom; “n” is an integer of 0 to 3.

14. A method of producing a volume hologram according to claim 9, wherein the photopolymerization initiator is a compound containing diaryliodonium skeleton represented by the following general formula (2): 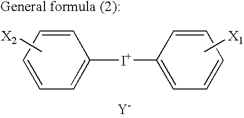
wherein, each of “X₁” and “X₂” is independently an alkyl group having 1 to 20 carbons, halogen or an alkoxyl group having 1 to 20 carbons; “Y⁻” is a monovalent anion.

15. A method of producing a volume hologram according to claim 9, wherein the maximum absorption wavelength of the sensitizing dye deviates by 14 nm or more with respect to a predetermined volume hologram recording wavelength set within a region of 514 nm to 560 nm.

16. A method of producing a volume hologram according to claim 15, wherein the volume hologram recording wavelength is set within a region of 514 nm to 560 nm and the sensitizing dye is selected from a group consisting of the following compounds (3) and (4): 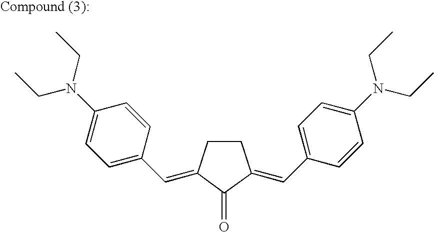
Chemical name: 2,5-bis(4-diethylaminobenzylidene)cyclopentanone; 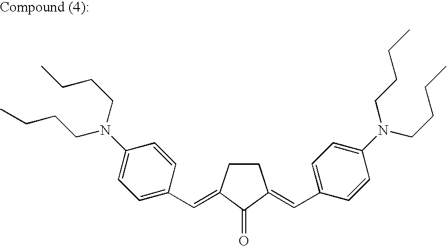
Chemical name: 2,5-bis(4-dibutylaminobenzylidene)cyclopentanone.

17. A method of producing a volume hologram according to claim 9, wherein the volume hologram recording wavelength is set within a region of 630 nm to 670 nm and the sensitizing dye is selected from a group consisting of the following compounds (1) and (2): 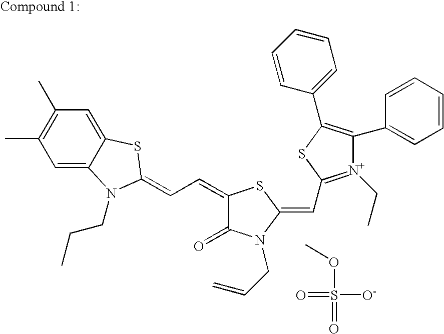
Chemical name: 2-[[3-allyl-5-[2-(5,6-dimethyl-3-propyl-2(3H) -benzothiazolylidene)ethylidene]-4-oxo-2-thiazolidinylidene]methyl]-3-ethyl-4,5-diphenylthiazolium methylsulfate; 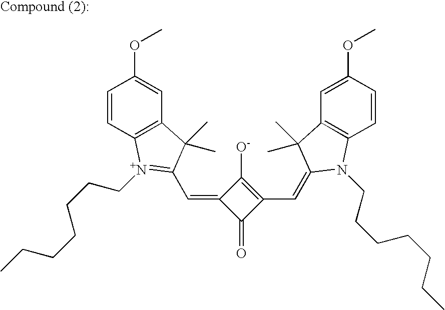
Chemical name: 1-heptyl-2-[3-(1-heptyl-5-methoxy-3,3-dimethyl -1,3-dihydro-indole-2-ilidenemethyl)-2-hydroxy-4-oxo-2-cyclobutenylidenemethyl]-5-methoxy-3,3-dimethyl-3H-indolium inner salt.

18. A method of producing a volume hologram according to claim 9, wherein the volume hologram recording wavelength is set within a region of 420 nm to 488 nm and the sensitizing dye is selected from a group consisting of the following compounds (5) and (6): 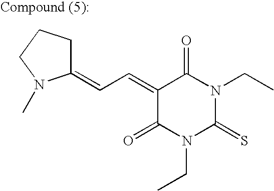
Chemical name: 1,3-diethyl-5-[2-(1-methyl-pyrrolidine-2-ilidene)-ethylidene]-2-thioxo-dihydro-pyrimidine-4,6-dione; 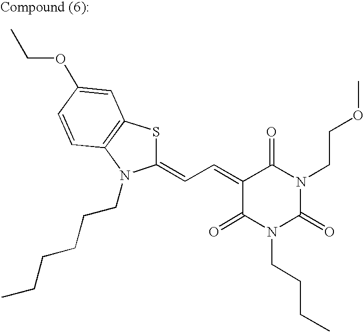
Chemical name: 1-butyl-5-[2-(6-ethoxy-3-hexyl-3H-benzothiazole -2-ilidene)-ethylidene]-3-(2-methoxy-ethyl)-pyrimidine -2,4,6-trione.

19. A method of producing a volume hologram according to claim 9, wherein a volume hologram having a diffraction efficiency of 80% or more can be obtained.

20. A photosensitive composition for volume hologram recording comprising a photopolymerizable compound as a refractive index modulation component, a photopolymerization initiator, a sensitizing dye which increases sensitivity of the photopolymerization initiator with respect to a wavelength of a visible region and a binder resin and/or a thermosetting compound, wherein the composition itself has absorption at a predetermined volume hologram recording wavelength set in a visible region and the sensitizing dye is a cyclopentanone skeleton containing compound represented by the following general formula (1): 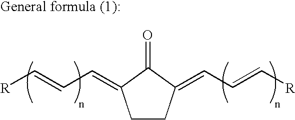
wherein, “R” is a carbon-nitrogen containing substituent represented by “NₓC_{y}” in which x=1 to 4, y=8 to 30; “R” may contain a hydrogen atom and/or a halogen atom; “n” is an integer of 0 to 3.

21. A photosensitive composition for volume hologram recording according to claim 20, wherein the photopolymerization initiator is a compound containing diaryliodonium skeleton represented by the following general formula (2): 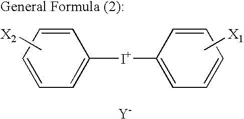
wherein, each of “X₁” and “X₂” is independently an alkyl group having 1 to 20 carbons, halogen or an alkoxyl group having 1 to 20 carbons; “Y⁻” is a monovalent anion.

22. A photosensitive composition for volume hologram recording according to claim 20, wherein the photopolymerizable compound is at least one kind selected from the group consisting of a photoradical polymerizable compound and a photocationic polymerizable compound.

23. A photosensitive composition for volume hologram recording according to claim 20, wherein the photosensitive composition for volume hologram recording further contains a second refractive index modulation component having different refractive index from the photopolymerizable compound.

24. A photosensitive composition for volume hologram recording according to claim 20, wherein a volume hologram having a diffraction efficiency of 80% or more can be obtained.

25. A photosensitive composition for volume hologram recording comprising a photopolymerizable compound as a refractive index modulation component, a photopolymerization initiator, a sensitizing dye which increases sensitivity of the photopolymerization initiator with respect to a wavelength of a visible region and a binder resin and/or a thermosetting compound, wherein the composition itself has absorption at a predetermined volume hologram recording wavelength set within a region of 514 nm to 560 nm and the sensitizing dye is selected from a group consisting of the following compounds (3) and (4): 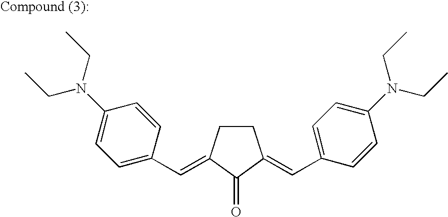
Chemical name: 2,5-bis(4-diethylaminobenzylidene)cyclopentanone; 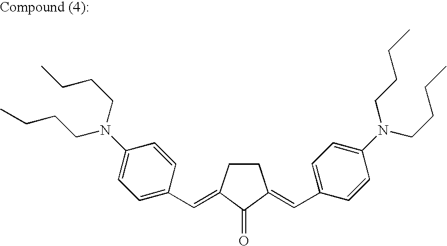
Chemical name: 2,5-bis(4-dibutylaminobenzylidene)cyclopentanone.

26. A photosensitive composition for volume hologram recording according to claim 25, wherein the photopolymerization initiator is a compound containing diaryliodonium skeleton represented by the following general formula (2): 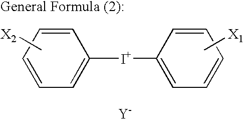
wherein, each of “X₁” and “X₂” is independently an alkyl group having 1 to 20 carbons, halogen or an alkoxyl group having 1 to 20 carbons; “Y⁻” is a monovalent anion.

27. A photosensitive composition for volume hologram recording according to claim 25, wherein the photopolymerizable compound is at least one kind selected from the group consisting of a photoradical polymerizable compound and a photocationic polymerizable compound.

28. A photosensitive composition for volume hologram recording according to claim 25, wherein the photosensitive composition for volume hologram recording further contains a second refractive index modulation component having different refractive index from the photopolymerizable compound.

29. A photosensitive composition for volume hologram recording according to claim 25, wherein a volume hologram having a diffraction efficiency of 80% or more can be obtained.

30. A photosensitive composition for volume hologram recording comprising a photopolymerizable compound as a refractive index modulation component, a photopolymerization initiator, a sensitizing dye which increases sensitivity of the photopolymerization initiator with respect to a wavelength of a visible region and a binder resin and/or a thermosetting compound, wherein the composition itself has absorption at a predetermined volume hologram recording wavelength set within a region of 630 nm to 670 nm and the sensitizing dye is selected from a group consisting of the following compounds (1) and (2): 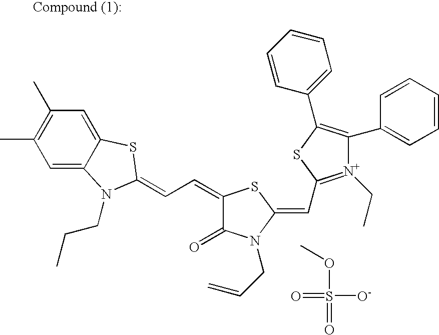
Chemical name: 2-[[3-allyl-5-[2-(5,6-dimethyl-3-propyl-2(3H) -benzothiazolylidene)ethylidene]-4-oxo-2-thiazolidinylidene]methyl]-3-ethyl-4,5-diphenylthiazolium methylsulfate; 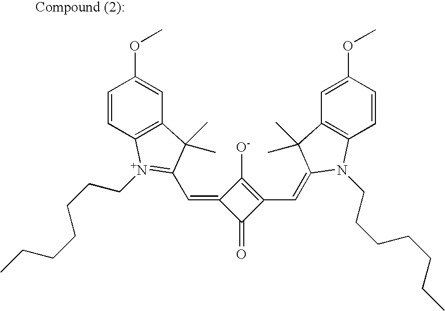
Chemical name: 1-heptyl-2-[3-(1-heptyl-5-methoxy-3,3-dimethyl -1,3-dihydro-indole-2-ilidenemethyl)-2-hydroxy-4-oxo-2-cyclobutenylidenemethyl]-5-methoxy-3,3-dimethyl-3H-indolium inner salt.

31. A photosensitive composition for volume hologram recording according to claim 30, wherein the photopolymerization initiator is a compound containing diaryliodonium skeleton represented by the following general formula (2): 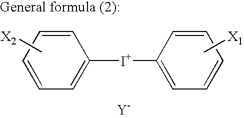
wherein, each of “X₁” and “X₂” is independently an alkyl group having 1 to 20 carbons, halogen or an alkoxyl group having 1 to 20 carbons; “Y⁻” is a monovalent anion.

32. A photosensitive composition for volume hologram recording according to claim 30, wherein the photopolymerizable compound is at least one kind selected from the group consisting of a photoradical polymerizable compound and a photocationic polymerizable compound.

33. A photosensitive composition for volume hologram recording according to claim 30, wherein the photosensitive composition for volume hologram recording further contains a second refractive index modulation component having different refractive index from the photopolymerizable compound.

34. A photosensitive composition for volume hologram recording according to claim 30, wherein a volume hologram having a diffraction efficiency of 80% or more can be obtained.

35. A photosensitive composition for volume hologram recording comprising a photopolymerizable compound as a refractive index modulation component, a photopolymerization initiator, a sensitizing dye which increases sensitivity of the photopolymerization initiator with respect to a wavelength of a visible region and a binder resin and/or a thermosetting compound, wherein the composition itself has absorption at a predetermined volume hologram recording wavelength set within a region of 420 nm to 488 nm and the sensitizing dye is selected from a group consisting of the following compounds (5) and (6): 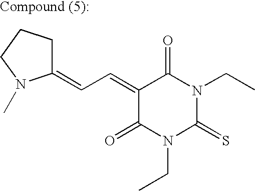
Chemical name: 1,3-diethyl-5-[2-(1-methyl-pyrrolidine-2-ilidene)-ethylidene]-2-thioxo-dihydro-pyrimidine-4,6-dione; 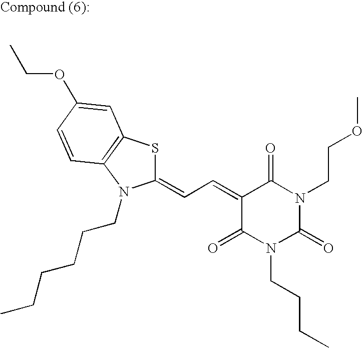
Chemical name: 1-butyl-5-[2-(6-ethoxy-3-hexyl-3H-benzothiazole -2-ilidene)-ethylidene]-3-(2-methoxy-ethyl)-pyrimidine -2,4,6-trione.

36. A photosensitive composition for volume hologram recording according to claim 35, wherein the photopolymerization initiator is a compound containing diaryliodonium skeleton represented by the following general formula (2): 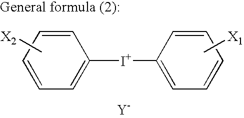
wherein, each of “X₁” and “X₂” is independently an alkyl group having 1 to 20 carbons, halogen or an alkoxyl group having 1 to 20 carbons; “Y⁻” is a monovalent anion.

37. A photosensitive composition for volume hologram recording according to claim 35, wherein the photopolymerizable compound is at least one kind selected from the group consisting of a photoradical polymerizable compound and a photocationic polymerizable compound.

38. A photosensitive composition for volume hologram recording according to claim 35, wherein the photosensitive composition for volume hologram recording further contains a second refractive index modulation component having different refractive index from the photopolymerizable compound.

39. A photosensitive composition for volume hologram recording according to claim 35, wherein a volume hologram having a diffraction efficiency of 80% or more can be obtained.
